(19) United States
(12) Patent Application Publication
(10) Pub. No.: US 2008/0315784 A1
(43) Pub. Date: Dec. 25, 2008

(54) LED LAMP STRUCTURE

(76) Inventor: Jui-Kai Tseng, Taipei City (TW)

Correspondence Address: APEX JURIS, PLLC, 12360 LAKE CITY WAY NORTHEAST, SUITE 410, SEATTLE, WA, 98125, US

(21) Appl. No.: 11/767,766

(22) Filed: Jun. 25, 2007

(51) Int. Cl. H05B 41/16

(52) U.S. Cl. 315/250

(57) ABSTRACT

The present invention provides an LED lamp structure, including a circuit board, a circular coil, and a lamp housing. The circuit board has one or more LED light bulb mounted thereon, and the circular coil includes an iron core, a primary winding and a secondary winding, wherein the primary winding of the circular coil is connected with the lamp housing for conducting an AC power, and then, the secondary winding, which is connected with the circuit board, is induced to produce a DC power for transmitting to the circuit board, thereby lighting up the LED light bulb on the circuit board.

### FIELD OF THE INVENTION

The present invention is related to an LED lamp structure, and more particularly to a lamp structure which utilizes LED as light source and a circular coil to combine with the lamp holder for providing stable power.

### BACKGROUND OF THE INVENTION

LED (light-emitting diode) is advantageous of high illumination, little power consumption and long life, so that it is gradually applied to various kinds of illuminating equipments, and other functions, such as water proofing, high illumination, adjustable lighting mode, decorating, are also developed. For LED lamp, the more complicated technology is the supplying of stable DC power. The conventional LED lamp, as shown in FIG. 1, may include a lamp housing 3, a circuit board 1, and a lampshade 4, wherein the lamp housing 3 includes a screwing portion 31 and two power connecting points 32, and the circuit board 1 is connected with plural LED light bulbs 2 and a light reflecting board. Generally, the DC power supply of the conventional LED lamp is converted by an electronic rectifier 5 from the AC power input, and however, the electronic rectifier 5 occupies lots of accommodating volume inside the lamp, so that the heat can not be dispersed well. Moreover, the electronic rectifier 5 is easily overheated to produce abnormal current, which might cause damage to the electronic rectifier 5 itself and/or the LED, so that the LED lamp employing the electronic rectifier 5 is easily broken due to the heat produced from long-term usage. Therefore, even though the life time of a general LED light bulb can be up to ten years, the life time of the LED lamp employing the electronic rectifier 5 will be less than that of LED light bulb. Furthermore, since the operation frequency of the electronic rectifier 5 is high, high frequency harmonic wave and EMI (Electromagnetic Interference) will be produced, and thus, if a lot of LED lamps, which respectively employ the electronic rectifier 5, are utilized, the power system and environment will be influenced by huge harmonic wave and EMI, so as to seriously effect the power quality. Consequently, the conventional LED lamp is hard to replace the traditional lamp, so that a novel LED lamp with a power supplying device, which can provide stable DC output and does not contaminate power quality, is extremely needed.

### SUMMARY OF THE INVENTION

Therefore, the object of the present invention is to provide a DC/AC power conversion device for an LED lamp so as to extend the life time and improve power quality thereof.

The present invention provides an LED lamp structure, including a circuit board, a circular coil, and a lamp housing. The circuit board has one or more LED light bulb mounted thereon, and plural power connecting points for connecting with the circular coil so as to acquire DC power. The circular coil includes an iron core, a primary winding and a secondary winding, wherein the secondary winding is connected with plural power connecting points on the circuit board outputs for electrically connecting the circuit board with the circular coil, and the primary winding is connected with the two power connecting points of the lamp housing for acquiring the AC power via the lamp housing, thereby lighting up the LED light bulb. Furthermore, the lamp housing has a hollow accommodating space for accommodating the circular coil, and the circuit board and the LED light bulb are mounted at one end of the lamp housing, thereby forming a lamp structure, which reduces EMI and high frequency harmonic waves through the great magnetic closed-loop characteristic of the circuit coil.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a decomposition drawing showing a conventional LED lamp;

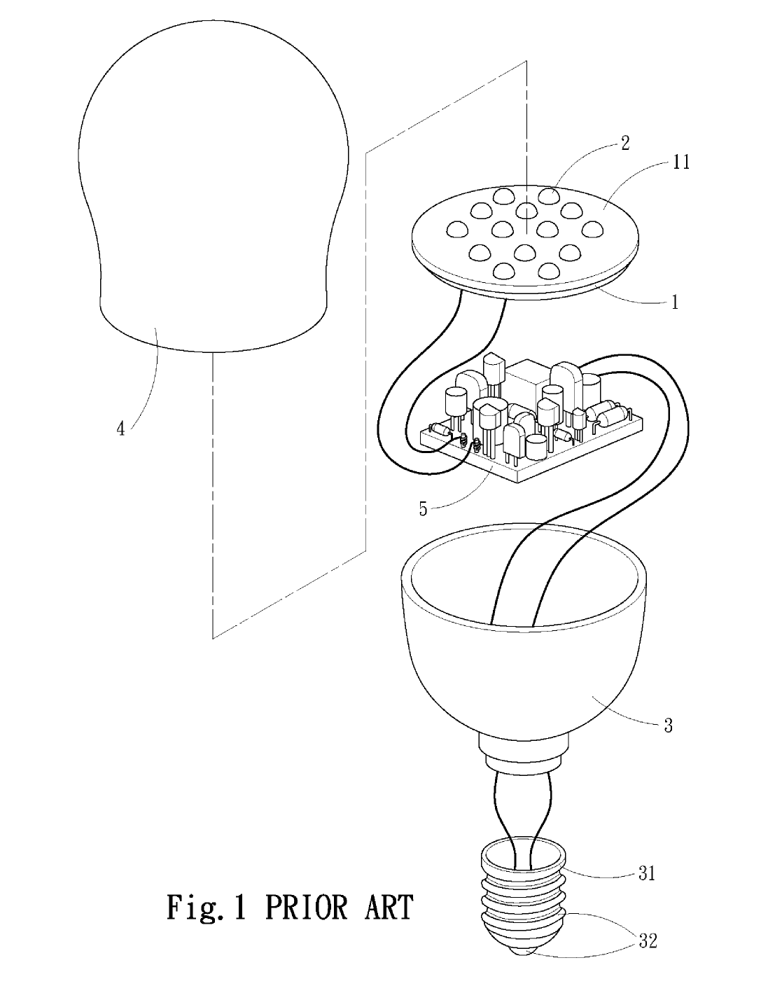

FIG. 2 is a decomposition drawing showing the present invention;

FIG. 3 is a decomposition drawing showing a circular coil according to the present invention;

FIG. 4 is a sectional drawing showing a circular coil according to the present invention; and

FIG. 5 is a three-dimensional drawing of the present invention.

### DESCRIPTION OF THE PREFERRED EMBODIMENT

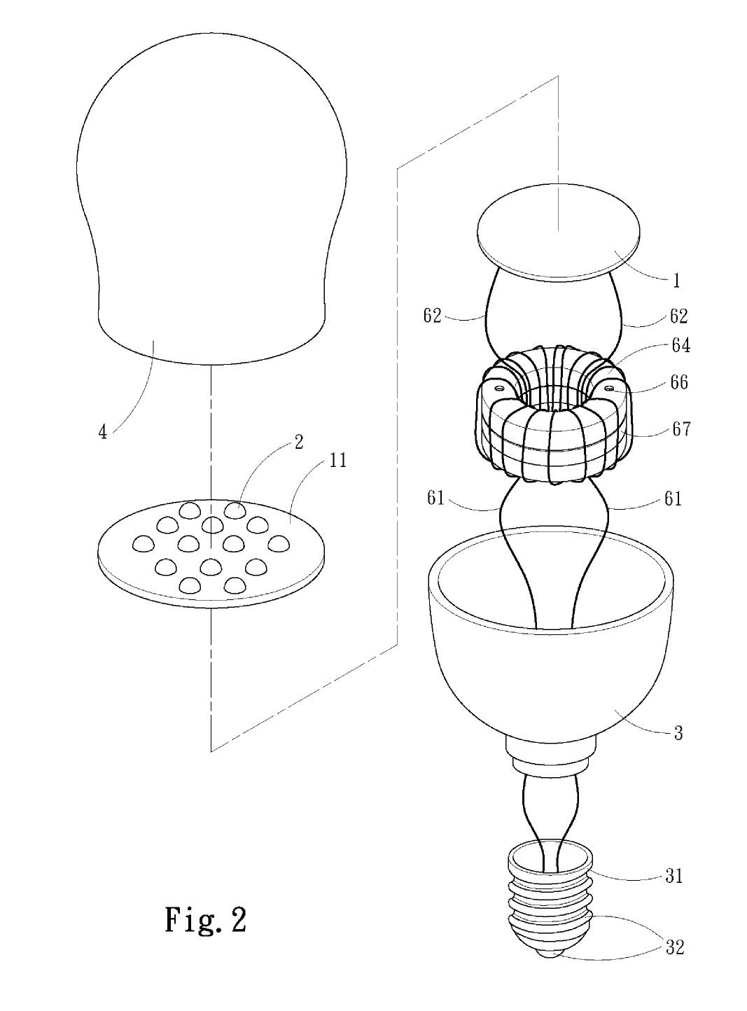

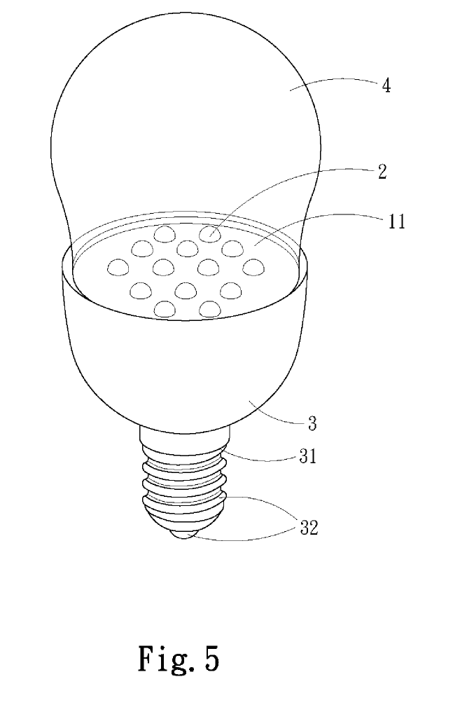

Please refer to FIGS. 2 and 5. As shown, a lamp structure includes a lamp housing 3, a circuit board 1, and a circular coil 6. The circuit board 1 is embedded under a light reflection board 11, which has at least a through hole for embedding at least one LED light bulb 2 in a geometric pattern, and the circuit board 1 has plural connecting points for respectively connecting with the circular coil 6 and the LED light bulbs 2, so that the circuit board 1 can draw the DC power from the circular coil 6 and then transmits thereof to the LED light bulb 2. The circular coil 6 at least includes an iron core 65, a primary winding 61 and a secondary winding 62, so as to form a power converting structure, wherein the secondary winding 61 is electrically connected with the connecting point of the circuit board 1. The lamp housing 3 has an accommodating space for accommodating the circular coil 6, and one end of the lamp housing has a screwing portion 31 with threads for combining with the lamp holder. Here, the screwing portion 31 has two power connecting points 32 for connecting with the primary winding 61 of the circular coil 6, which is accommodated in the lamp housing 3, the secondary winding 61 of the circular coil 6 is connected with the circuit board 1, which is embedded under the light reflection board 11, and the circuit board 1 is electrically connected with the LED bulbs 2, thereby a complete power loop is formed. Moreover, the light reflection board 11 is fastened on the lamp housing 3, so that the lamp housing 3, the circuit coil 6 and the circuit board 1 are integrated as a lamp structure. Besides, a lampshade 4 can be further combined with the lamp housing 3 at the upper end thereof for protecting the LED bulbs 2, as shown in FIG. 5. When the lamp housing 3 are screwed with the lamp holder, the primary winding 61 of the circular coil 6 may draw the AC power via the lamp housing 3, so that the secondary winding 62 of the circular coil 6 can be induced to output an non-harmonics power to the circuit board 1 for rectifying, thereby lighting up the LED bulbs 2. Therefore, through the great magnetic closed-loop characteristic of the circular coil 6, the EMI can be reduced and a low DC resistance can also be obtained, and the circular coil 6 is further advantageous of having small volume and great choke characteristic for providing pure DC power. In addition, the smaller occupied volume of the circular coil 6 is than the conventional electronic rectifier 5 also make the circular coil can be accommodated in all kinds of lamp holders for wider applications.

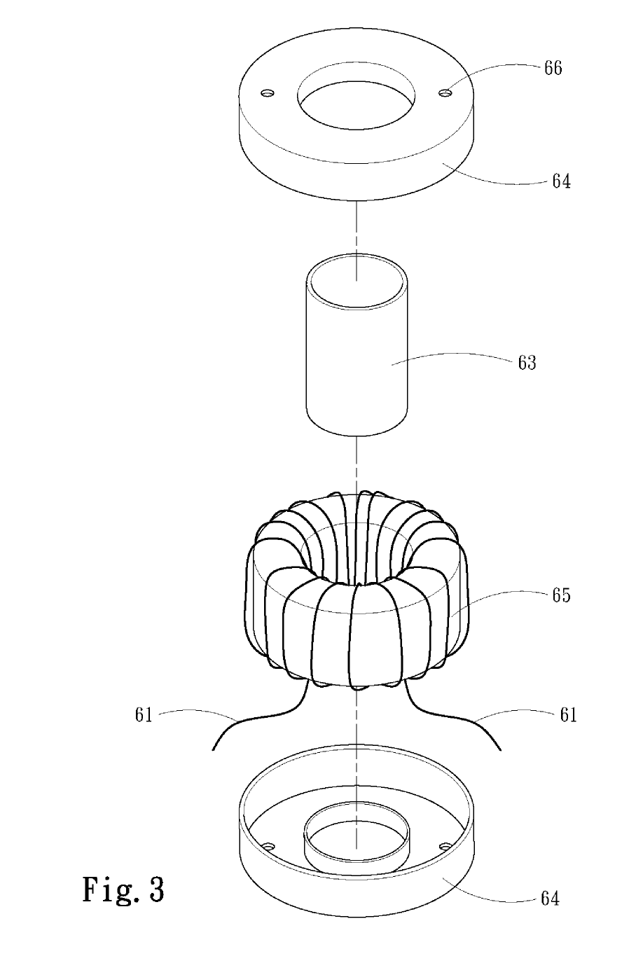

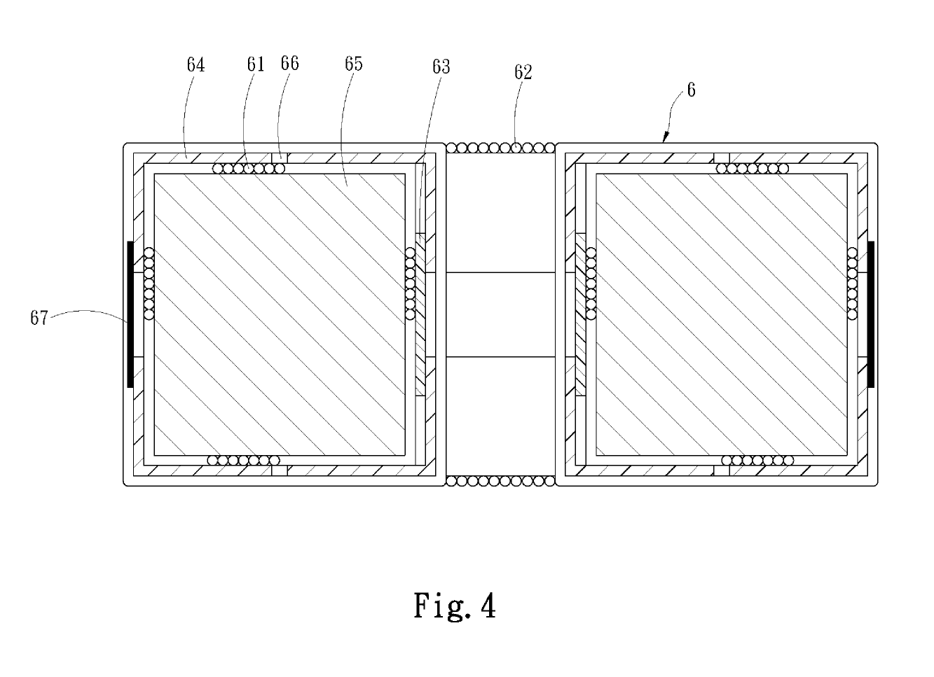

Please refer to FIGS. 3 and 4, which are respectively a three-dimensional drawing and a sectional drawing showing the circular coil 6 in an embodiment of the present invention. The circular coil 6 includes an iron core 65, a primary winding 61, a secondary winding 62, and a pair of covers 64, which isolate the iron core 65, the primary winding 61 and the secondary winding 62. Moreover, an inner tube 63 is mounted inside the covers 64, and openings 66 are mounted on the covers 64 for pulling out two ends of the primary winding 61. After the two ends of the primary winding 61 are penetrated through the openings 66, the covers 64 are covered together to isolate the iron core 65, the primary winding 61 and the secondary winding 62. Furthermore, a coating 67 can be added on the seam between two covers 64 for enhancing functions of isolation and water proofing. Then, the secondary winding 62 is wound on the covers 64, so as to generate current through a magnetic induction from the primary winding 61. Therefore, a circular coil 6 capable of providing stable power is formed. Through replacing the conventional electronic rectifier 5 by the circular coil 6, a stable DC power can be provided, so that the problems of contamination from high frequency harmonic wave, EMI and too-large volume hard to be applied to small lamp holder all can be solved. Since the circular coil 6 is suitable for lamp holder in various sizes, the volume of lamp holder will no longer be limited, and further, owing to the advantages of non-harmonic wave and noise and EMI free, the LED lamp according to the present invention is more suitable for general life

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An LED lamp structure, which is connected with an AC power source for converting thereof into a DC power so as to light up at least an LED light bulb, the LED lamp structure comprising:
a light reflection board, having through holes pre-mounted thereon for embedding at least an LED light bulb therein in a geometric pattern;
a circuit board, embedded under the light reflection board and having plural power connecting points for acquiring the DC power and for electrically connecting with the LED light bulb;
a circular coil, comprising an iron core which is wound by at least a primary winding and a secondary winding, wherein the secondary winding is connected with plural power connecting points of the circuit board so as to electrically connect the circuit board with the circular coil; and
a lamp housing, having a hollow accommodating space for accommodating the circular coil, wherein the circuit board and the LED light bulb are mounted at one end of the lamp housing, the lamp housing has two power connecting points mounted thereon for conducting the AC power, the primary winding of the circular coil is connected with the two power connecting points for acquiring the AC power via the lamp housing, and the secondary winding of the circular coil outputs non-harmonic power to the circuit board for lighting up the LED light bulb.

2. The LED lamp structure as claimed in claim 1, wherein the lamp housing further comprises a lampshade mounted at the end locating the circuit board.

3. The LED lamp structure as claimed in claim 1, wherein the lamp housing further comprises a screwing portion with threads at one end thereof for screwing with a lamp holder.

4. The LED lamp structure as claimed in claim 1, wherein plural power connecting points of the lamp housing are mounted at the screwing portion.

5. The LED lamp structure as claimed in claim 1, wherein the circular coil further comprises an inner tube located between the iron core and the primary winding, and a pair of covers symmetrically covered together for isolating the primary winding and the secondary winding.
